(19) United States
(12) Patent Application Publication
(10) Pub. No.: US 2026/0299386 A1
(43) Pub. Date: Oct. 1, 2026

(54) MULTICOLOR LIGHT MIXING MODULE

(71) Applicant: QISDA CORPORATION, Taoyuan City (TW)

(72) Inventors: Ching-Tze Huang, Taoyuan City (TW); Kai-Jiun Wang, Taoyuan City (TW)

(73) Assignee: QISDA CORPORATION, Taoyuan City (TW)

(21) Appl. No.: 19/562,741

(22) Filed: Mar. 10, 2026

(30) Foreign Application Priority Data
Mar. 28, 2025 (CN) 202510381336.5

(51) Int. Cl. G03B 21/20

(52) U.S. Cl. CPC G03B 21/2033; G03B 21/2066

(57) ABSTRACT

A multicolor light mixing module includes a first laser set emitting first and second color lights, a second laser set emitting a third color light, a first light-mixing member having first and second refractive surfaces and a reflective surface, and a second light-mixing member. The first refractive surface reflects the first color light to travel along a first light-mixing axis and allows the second color light to pass through. The reflective surface reflects the second color light to travel along the first light-mixing axis through the first refractive surface. The second refractive surface reflects the third color light to travel along a light-exit axis coplanar with the first light-mixing axis. The second light-mixing member is disposed on the first light-mixing axis and the light-exit axis for reflecting the first, second and third color lights to form a multicolor laser beam in a second light-mixing axis.

### BACKGROUND OF THE INVENTION

### 1. FIELD OF THE INVENTION

The present invention relates to a multicolor light mixing module, and more specifically, to a multicolor light mixing module utilizing a first light-mixing member to perform coplanar light mixing on a first color light, a second color light and a third color light and utilizing a second light-mixing member to perform single-axis light mixing on the coplanar first, second and third color lights.

### 2. DESCRIPTION OF THE PRIOR ART

In general, a conventional laser projection apparatus adopts a light mixing module to provide a multicolor laser beam for subsequent image projection. In the practical application, for further reducing an overall volume of a laser source of the laser projection apparatus, the common design involves packaging red, green, and blue laser diodes in a side-by-side arrangement into one multicolor laser source module, so as to simultaneously provide red, green and blue color lights to the light mixing module of the laser projection apparatus.

However, since the aforesaid packaging design only arranges the red, green, and blue laser diodes in multiple rows sequentially (e.g., arranging a plurality of red laser diodes in a row and arranging a plurality of green and blue laser diodes in another row), it may cause an uneven color distribution problem on an image projected by the laser projection apparatus (e.g., the image having a greenish upper portion and a bluish lower portion), so as to reduce the image projection quality of the laser projection apparatus.

### SUMMARY OF THE INVENTION

The present invention provides a multicolor light mixing module suitable for providing a multicolor laser beam to a laser projection apparatus. The multicolor light mixing module includes a first laser set, a second laser set, a first light-mixing member, and a second light-mixing member. The first laser set includes a plurality of first lighting units and a plurality of second lighting units arranged in sequence. The plurality of first lighting units emits a first color light, and the plurality of second lighting units emits a second color light. The second laser set is adjacent to the first laser set and includes a plurality of third lighting units arranged in sequence. The plurality of third lighting units emits a third color light. The first light-mixing member is disposed at a position opposite to the first laser set and the second laser set and has a first refractive surface, a reflective surface, and a second refractive surface, wherein the first refractive surface is disposed obliquely to reflect the first color light to travel along a first light-mixing axis and allow the second color light to pass through and be incident to the reflective surface, the reflective surface is disposed obliquely to reflect the second color light to pass through the first refractive surface and travel along the first light-mixing axis, the second refractive surface is disposed obliquely to reflect the third color light to travel along a light-exit axis, and the light-exit axis is coplanar with the first light-mixing axis. The second light-mixing member is disposed on the first light-mixing axis and the light-exit axis, for reflecting the first color light, the second color light, and the third color light to form a multicolor laser beam along a second light-mixing axis.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a multicolor light mixing module according to an embodiment of the present invention.

FIG. 2 is a front view of the multicolor light mixing module in FIG. 1.

FIG. 3 is an optical path diagram of a first color light, a second color light, and a third color light in FIG. 1 entering a second light-mixing member to form a multicolor laser beam.

FIG. 4 is an optical path diagram of the first color light, the second color light, and the third color light entering a second light-mixing member to form the multicolor laser beam according to another embodiment of the present invention.

FIG. 5 is an optical path diagram of the first color light, the second color light, and the third color light entering a second light-mixing member to form the multicolor laser beam according to another embodiment of the present invention.

FIG. 6 is a diagram of a multicolor light mixing module according to another embodiment of the present invention.

FIG. 7 is a front view of the multicolor light mixing module in FIG. 6.

FIG. 8 is a diagram of a multicolor light mixing module according to another embodiment of the present invention.

FIG. 9 is a front view of the multicolor light mixing module in FIG. 8.

FIG. 10 is a diagram of a multicolor light mixing module according to another embodiment of the present invention.

FIG. 11 is a front view of the multicolor light mixing module in FIG. 10.

### DETAILED DESCRIPTION

The present invention will now be described more specifically with reference to the following embodiments and the accompanying drawings. Other advantages and effects of the present invention can be easily understood by a person ordinarily skilled in the art in view of the detailed descriptions and the accompanying drawings. The present invention can be implemented or applied to other different embodiments. Certain aspects of the present invention are not limited by the particular details of the examples illustrated herein. Without departing from the spirit and scope of the present invention, the present invention will have other modifications and changes. It should be understood that the appended drawings are not necessarily drawn to the scale and configuration of each component (e.g., structural sizes and configuration of lighting units and light-mixing members) in the drawings is merely illustrative, not presenting an actual condition of the embodiments.

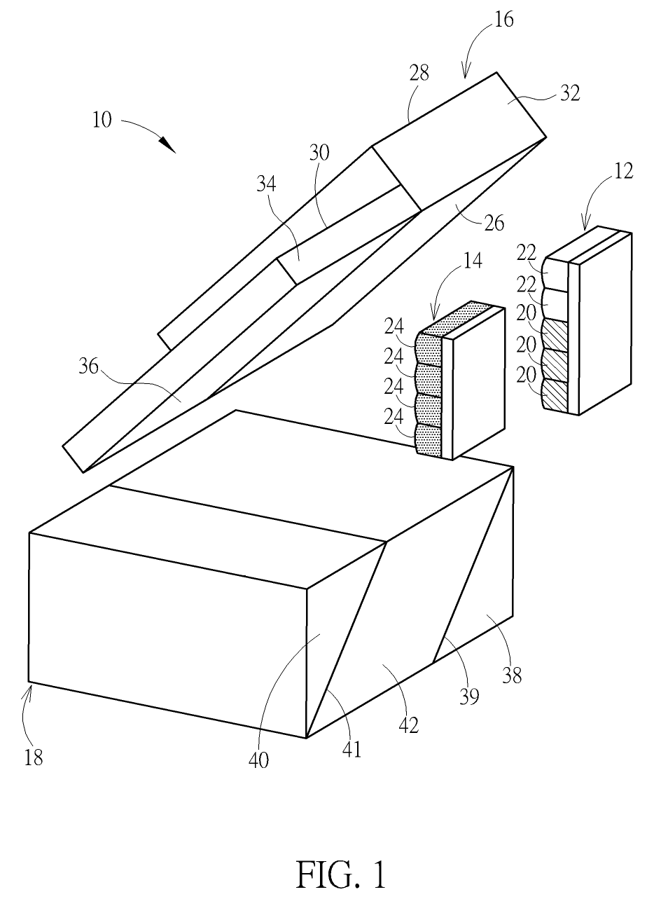

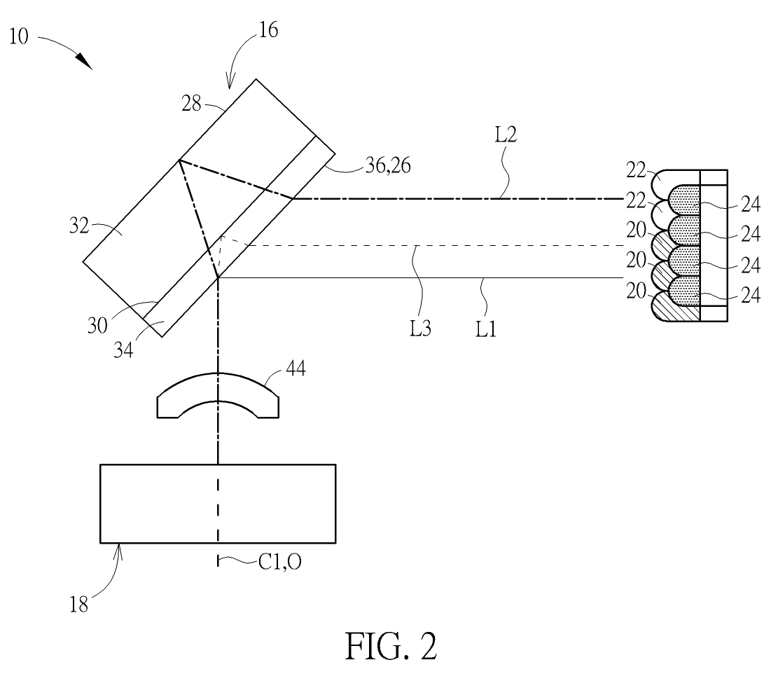

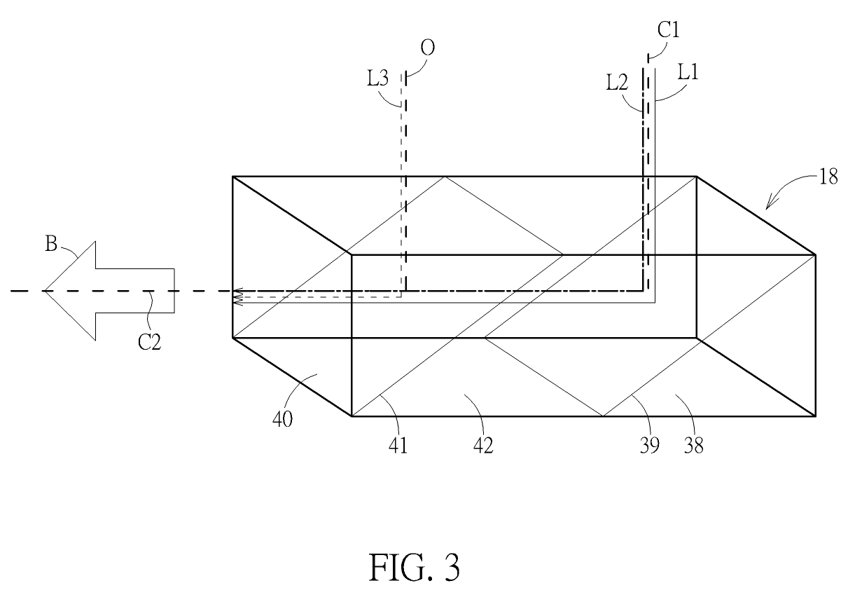

Please refer to FIGS. 1, 2, and 3. FIG. 1 is a diagram of a multicolor light mixing module 10 according to an embodiment of the present invention. FIG. 2 is a front view of the multicolor light mixing module 10 in FIG. 1. FIG. 3 is an optical path diagram of a first color light L1, a second color light L2, and a third color light L3 in FIG. 1 entering a second light-mixing member 18 to form a multicolor laser beam B. As shown in FIGS. 1, 2, and 3, the multicolor light mixing module 10 is utilized to provide a multicolor laser beam to a laser projection apparatus for subsequent projection imaging. The multicolor light mixing module 10 includes a first laser set 12, a second laser set 14, a first light-mixing member 16, and the second light-mixing member 18.

The first laser set 12 includes a plurality of first lighting units 20 (three shown in FIG. 1, but not limited thereto) and a plurality of second lighting units 22 (two shown in FIG. 1, but not limited thereto) arranged sequentially, and the second laser set 14 is adjacent to the first laser set 12 and includes a plurality of third lighting units 24 (four shown in FIG. 1, but not limited thereto) arranged sequentially. The first lighting unit 20 could be preferably a green laser diode for emitting the first color light L1 (i.e., green light). The second lighting unit 22 could be preferably a blue laser diode for emitting the second color light L2 (i.e., blue light). The third lighting unit 24 could be preferably a red laser diode for emitting the third color light L3 (i.e., red light). The present invention is not limited to the aforesaid design, meaning that the color light configuration and the type of light source could be varied with the practical application of the multicolor light mixing module 10. Furthermore, in this embodiment, as shown in FIG. 1, the first lighting units 20 and the second lighting units 22 could be arranged in blue-blue-green-green-green order from up to down vertically and the third lighting units 24 could be arranged in red-red-red-red order from up to down vertically, but the present invention is not limited thereto.

The first light-mixing member 16 is disposed at a position opposite to the first laser set 12 and the second laser set 14, and has a first refractive surface 26, a reflective surface 28, and a second refractive surface 30. The first refractive surface 26 is disposed obliquely for reflecting the first color light L1 to travel along a first light-mixing axis C1 and allowing the second color light L2 to pass through and be incident onto the reflective surface 28. The reflective surface 28 is disposed obliquely for reflecting the second color light L2 to pass through the first refractive surface 26 and travel along the first light-mixing axis C1. The second refractive surface 30 is disposed obliquely for reflecting the third color light L3 to travel along a light-exit axis O.

To be more specific, in this embodiment, the first light-mixing member 16 could include a first dichroic mirror 32 and a second dichroic mirror 34, and could further have a third refractive surface 36. The first dichroic mirror 32 could be oblique to face the first laser set 12 (the inclination angle of the first dichroic mirror 32 is preferably equal to 45°, but not limited thereto). The second dichroic mirror 34 could be oblique to face the second laser set 14 (the inclination angle of the second dichroic mirror 34 is preferably equal to 45°, but not limited thereto). The first refractive surface 26 could be formed at a light-entrance surface position of the first dichroic mirror 32. The reflective surface 28 could be formed at a back surface position of the first dichroic mirror 32. The second refractive surface 30 could be formed at a back surface position of the second dichroic mirror 34. The third refractive surface 36 could be formed at a light-entrance surface position of the second dichroic mirror 34. The second dichroic mirror 34 is connected to one side of the first dichroic mirror 32 such that the first refractive surface 26 is flush with the third refractive surface 36, and a thickness of the first dichroic mirror 32 is greater than a thickness of the second dichroic mirror 34 so that the reflective surface 28 and the second refractive surface 30 are not coplanar (as shown in FIG. 1). Accordingly, the first refractive surface 26 can reflect the first color light L1 to travel along the first light-mixing axis C1 and allow the second color light L2 to pass through and be incident onto the reflective surface 28. The reflective surface 28 can reflect the second color light L2 to pass through the first refractive surface 26 and then travel along the first light-mixing axis C1. The third refractive surface 36 can allow the third color light L3 to pass through. The second refractive surface 30 can reflect the third color light L3 to pass through the third refractive surface 36 and then travel along the light-exit axis O. In such a manner, via the aforementioned light guiding design, the first light-mixing member 16 can guide the first color light L1, the second color light L2, and the third color light L3 to travel respectively along coplanar optical axes (i.e., the first light-mixing axis C1 and the light-exit axis O as shown in FIG. 3), so as to provide coplanar color lights required for the second light-mixing member 18 to perform light mixing on a second light-mixing axis C2.

As shown in FIG. 3, the second light-mixing member 18 is disposed on the first light-mixing axis C1 and the light-exit axis O. As such, after the first light-mixing member 16 performs coplanar light mixing on the first color light L1, the second color light L2, and the third color light L3, the second light-mixing member 18 could be used to reflect the first color light L1, the second color light L2, and the third color light L3 to travel along the second light-mixing axis C2 to form the multicolor laser beam B. More specifically, in this embodiment, the second light-mixing member 18 could include a first prism column 38, a second prism column 40, and a third prism column 42. The first prism column 38 and the second prism column 40 could be respectively disposed on the first light-mixing axis C1 and the light-exit axis O. The third prism column 42 is spliced between the first prism column 38 and the second prism column 40. A first splicing surface 39 between the third prism column 42 and the first prism column 38 is oblique on the first light-mixing axis C1 (the inclination angle of the first splicing surface 39 could be preferably equal to 45°, but not limited thereto), and a second splicing surface 41 between the third prism column 42 and the second prism column 40 is oblique on the light-exit axis O (the inclination angle of the second splicing surface 41 could be preferably equal to 45°, but not limited thereto). Accordingly, as shown in FIG. 3, the first splicing surface 39 can reflect the first color light L1 and the second color light L2 to travel along the second light-mixing axis C2, and the second splicing surface 41 can reflect the third color light L3 to travel along the second light-mixing axis C2 and allow the first color light L1 and the second color light L2 to pass through, so as to mix the third color light L3 with the first color light L1 and the second color light L2 on the second light-mixing axis C2 to form the multicolor laser beam B (as shown in FIG. 3), thereby achieving the single-axis light mixing effect, and further providing the multicolor laser beam to the laser projection apparatus for subsequent projection imaging.

To be noted, as shown in FIG. 2, the multicolor light mixing module 10 could further include at least one condensing lens 44 (one shown in FIG. 2, but not limited thereto). The condensing lens 44 (e.g., a convex lens, a cylindrical lens, or any lens combination thereof) is disposed between the first light-mixing member 16 and the second light-mixing member 18. For example, the condensing lens 44 could be disposed on the light-exit axis O to perform collimation and condensing on the third color light L3, but the present invention is not limited thereto. The configuration and quantity of lenses depend on the actual manufacturing application requirements of the multicolor light mixing module 10.

Furthermore, the second light-mixing member of the present invention could adopt a reverse light mixing configuration. For example, in another embodiment, the first splicing surface 39 could adopt a reverse inclination configuration to reflect the first color light L1 and the second color light L2 to travel reversely along the second light-mixing axis C2 and allow the third color light L3 to pass through, and the second splicing surface 41 could adopt a reverse inclination configuration to reflect the third color light L3 to pass through the first splicing surface 39, so as to mix the third color light L3 with the first color light L1 and the second color light L2 on the second light-mixing axis C2 to form a reversely emitted multicolor laser beam, which similarly achieves the single-axis light mixing effect. As for which configuration is adopted, it depends on the actual manufacturing application requirements of the multicolor light mixing module of the present invention.

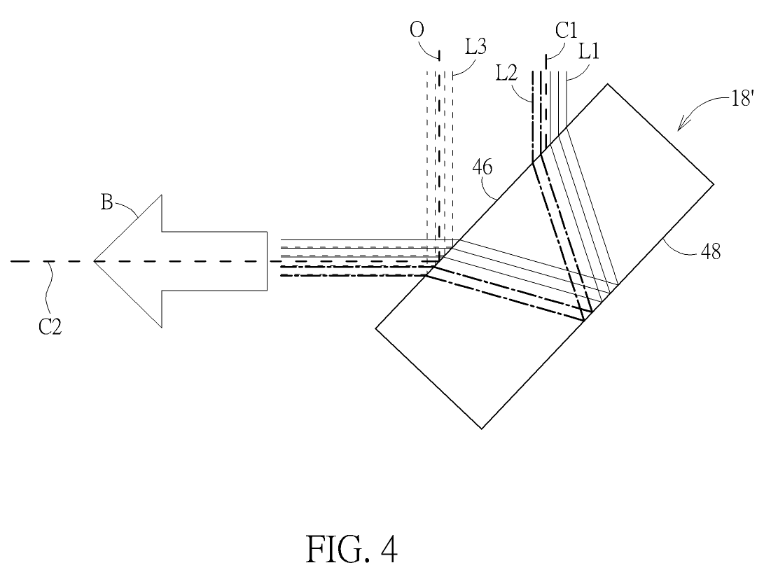

In practical applications, the second light-mixing member of the present invention is not limited to the aforesaid prism column design, meaning that the present invention could adopt a single-piece dichroic reflective mirror design. For example, please refer to FIG. 4, which is an optical path diagram of the first color light L1, the second color light L2, and the third color light L3 entering a second light-mixing member 18' to form the multicolor laser beam B according to another embodiment of the present invention. Components both mentioned in this embodiment and the aforesaid embodiments represent components with similar structures or functions, and the related description could be reasoned by analogy according to the aforesaid embodiments and omitted herein. As shown in FIG. 4, in this embodiment, the second light-mixing member 18' could be a dichroic reflective mirror. A light-entrance surface 46 of the second light-mixing member 18' allows the first color light L1 and the second color light L2 to pass through and reflects the third color light L3 to travel along the second light-mixing axis C2. A back surface 48 of the second light-mixing member 18' reflects the first color light L1 and the second color light L2 to pass through the light-entrance surface 46, such that the first color light L1 and the second color light L2 can be mixed with the third color light L3 on the second light-mixing axis C2 for forming the multicolor laser beam B, thereby achieving the single-axis light mixing effect. Similarly, as known from the above, the second light-mixing member 18' could adopt a reverse light mixing configuration. For example, in another embodiment, the second light-mixing member 18' could adopt a reverse inclination configuration to reflect the first color light L1 and the second color light L2 via the light-entrance surface 46 to travel reversely along the second light-mixing axis C2 and allow the third color light L3 to pass through, and the second light-mixing member 18' reflects the third color light L3 via the back surface 48 to pass through the light-entrance surface 46, so as to mix the third color light L3 with the first color light L1 and the second color light L2 on the second light-mixing axis C2 to form a reversely emitted multicolor laser beam, thereby achieving the single-axis light mixing effect. As for which configuration is adopted, it depends on the actual manufacturing application requirements of the multicolor light mixing module of the present invention.

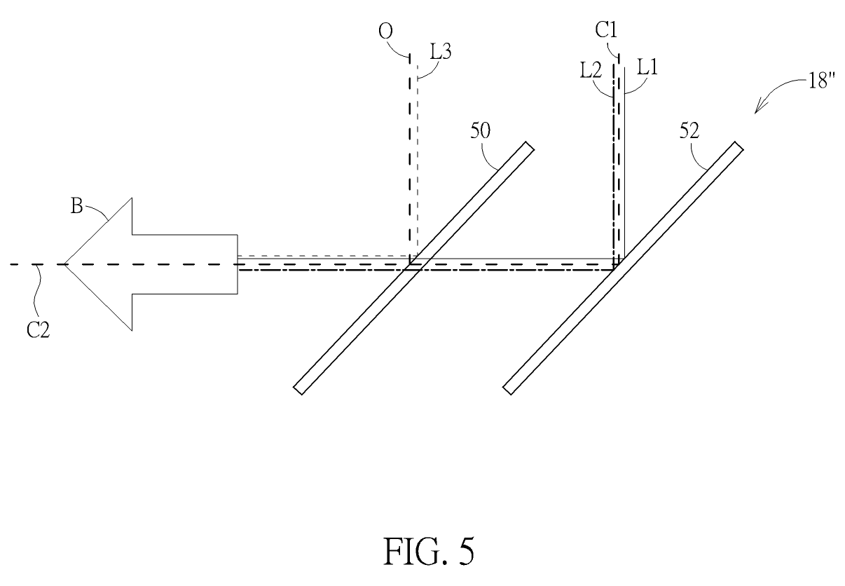

In addition, the second light-mixing member of the present invention could adopt a two-piece dichroic reflective mirror design. For example, please refer to FIG. 5, which is an optical path diagram of the first color light L1, the second color light L2, and the third color light L3 entering a second light-mixing member 18" to form the multicolor laser beam B according to another embodiment of the present invention. Components both mentioned in this embodiment and the aforesaid embodiments represent components with similar structures or functions, and the related description could be reasoned by analogy according to the aforesaid embodiments and omitted herein. As shown in FIG. 5, in this embodiment, the second light-mixing member 18" could include a dichroic mirror 50 and a reflective mirror 52. The dichroic mirror 50 is oblique on the light-exit axis O (the inclination angle of the dichroic mirror 50 could be preferably equal to 45°, but not limited thereto) to reflect the third color light L3 to travel along the second light-mixing axis C2 and allow the first color light L1 and the second color light L2 to pass through. The reflective mirror 52 is oblique on the first light-mixing axis C1 (the inclination angle of the reflective mirror 52 could be preferably equal to 45°, but not limited thereto) to reflect the first color light L1 and the second color light L2 to pass through the dichroic mirror 50, such that the first color light L1 and the second color light L2 can be mixed with the third color light L3 on the second light-mixing axis C2 to form the multicolor laser beam B. As such, the single-axis light mixing effect can be achieved. Similarly, as known from the above, the second light-mixing member 18" could adopt a reverse light mixing configuration. For example, in another embodiment, the dichroic mirror 50 could adopt a reverse inclination configuration to reflect the first color light L1 and the second color light L2 to travel reversely along the second light-mixing axis C2 and allow the third color light L3 to pass through, and the reflective mirror 52 could adopt a reverse inclination configuration to reflect the third color light L3 to pass through the dichroic mirror 50, causing the third color light L3 to be mixed with the first color light L1 and the second color light L2 on the second light-mixing axis C2 to form a reversely emitted multicolor laser beam. As such, the single-axis light mixing effect can be achieved. As for which configuration is adopted, it depends on the actual manufacturing application requirements of the multicolor light mixing module of the present invention.

Via the aforementioned design of utilizing the first light-mixing member to perform coplanar light mixing on the first color light, the second color light, and the third color light, and then utilizing the second light-mixing member to perform single-axis light mixing on the coplanar first color light, second color light, and third color light, the present invention can achieve the single-axis light mixing effect and provide the laser beam with multicolor light distributed in proper proportions even in the configuration that the red, green, and blue laser diodes are arranged in multiple rows sequentially (e.g., arranging a plurality of red laser diodes in a row and arranging a plurality of green and blue laser diodes in another row) aforementioned in the prior art. In such a manner, the present invention can efficiently solve the uneven color distribution problem on the image projected by the laser projection apparatus (e.g., the image having a greenish upper portion and a bluish lower portion) aforementioned in the prior art, so as to greatly improve the image projection quality and color uniformity of the laser projection apparatus.

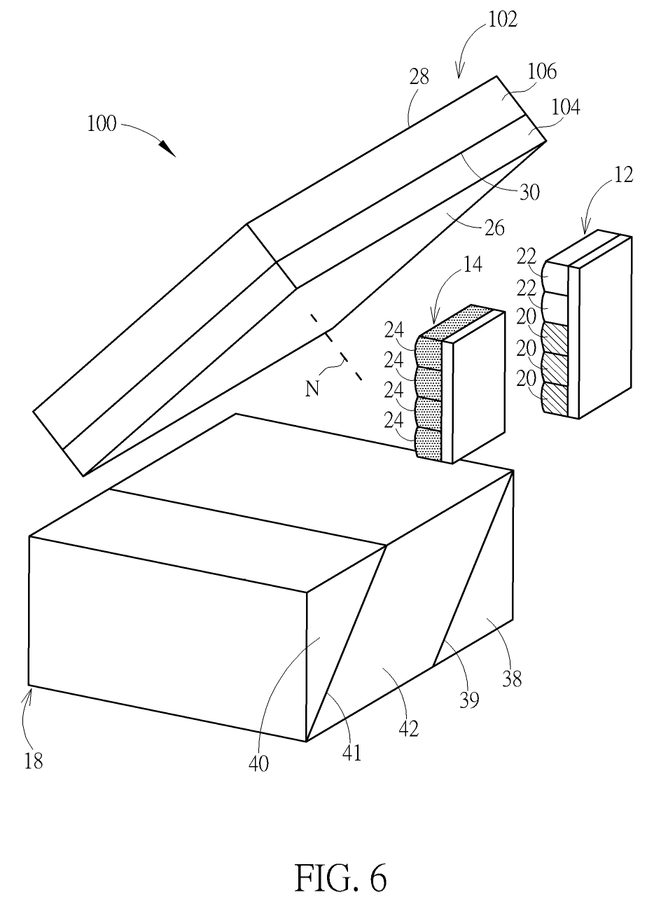

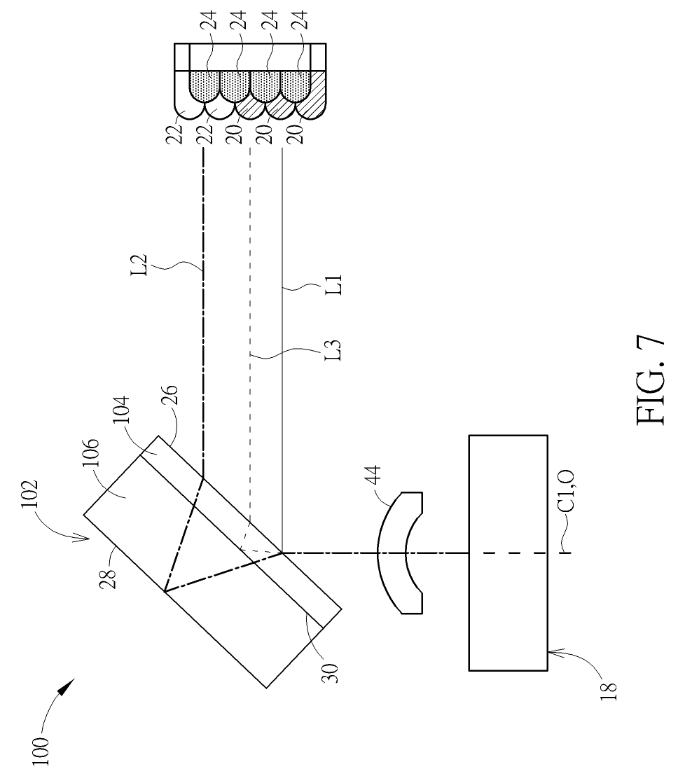

It should be mentioned that the first light-mixing member of the present invention is not limited to the aforementioned unequal thickness dichroic mirror design, which means the present invention could adopt a stacked dichroic reflective mirror design. For example, please refer to FIGS. 6 and 7. FIG. 6 is a diagram of a multicolor light mixing module 100 according to another embodiment of the present invention. FIG. 7 is a front view of the multicolor light mixing module 100 in FIG. 6. Components both mentioned in this embodiment and the aforesaid embodiments represent components with similar structures or functions, and the related description could be reasoned by analogy according to the aforesaid embodiments and omitted herein. As shown in FIGS. 6 and 7, the multicolor light mixing module 100 includes the first laser set 12, the second laser set 14, a first light-mixing member 102, and the second light-mixing member 18. In this embodiment, the first light-mixing member 102 includes a dichroic mirror 104 and a reflective mirror 106, and has the first refractive surface 26, the reflective surface 28, and the second refractive surface 30. The dichroic mirror 104 is oblique to face the first laser set 12 and the second laser set 14 (the inclination angle of the dichroic mirror 104 could be preferably equal to 45°, but not limited thereto). The first refractive surface 26 is formed at a light-entrance surface position of the dichroic mirror 104 to reflect the first color light L1 and allow the second color light L2 and the third color light L3 to pass through. The dichroic mirror 104 and the reflective mirror 106 could be stacked and connected to each other along a normal axis N of the first refractive surface 26. The second refractive surface 30 is formed at a position where the reflective mirror 106 and the dichroic mirror 104 are stacked and connected (for example, the second refractive surface 30 could be respectively formed at a back surface position of the dichroic mirror 104 and a light-entrance surface position of the reflective mirror 106, but not limited thereto), for reflecting the third color light L3 and allowing the second color light L2 to pass through. The reflective surface 28 is formed at a back surface position of the reflective mirror 106 to reflect the second color light L2 to sequentially pass through the second refractive surface 30 and the first refractive surface 26 and then travel along the first light-mixing axis C1.

In such a manner, via the aforementioned light guiding design and by properly controlling structural thicknesses of the dichroic mirror 104 and the reflective mirror 106, the first light-mixing member 102 can guide the first color light L1, the second color light L2, and the third color light L3 to travel along the coplanar optical axes (i.e., the first light-mixing axis C1 and the light-exit axis O as shown in FIG. 7), so as to provide coplanar color lights required for the second light-mixing member 18 to perform light mixing on the second light-mixing axis C2. To be noted, in addition to utilizing the second light-mixing member 18 (with the prism column design) as shown in FIG. 6 for subsequent single-axis light mixing, other derivative embodiments for the second light-mixing member (e.g., the reverse light mixing configuration, the single-piece dichroic reflective mirror design, and the two-piece dichroic reflective mirror design) can all be selectively applied to the multicolor light mixing module 100, and the related descriptions could be reasoned by analogy according to the aforesaid embodiments and omitted herein.

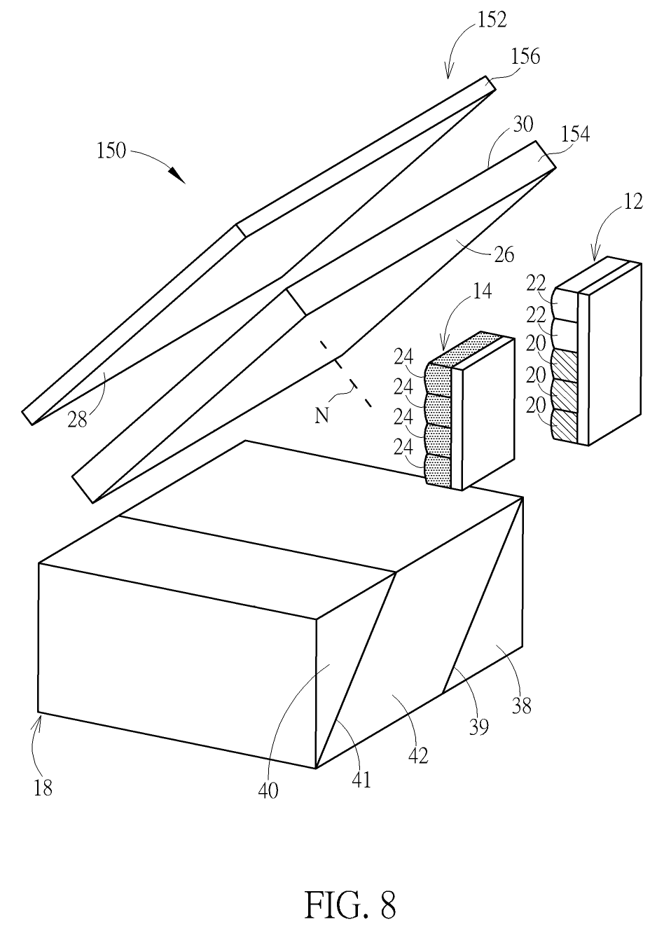

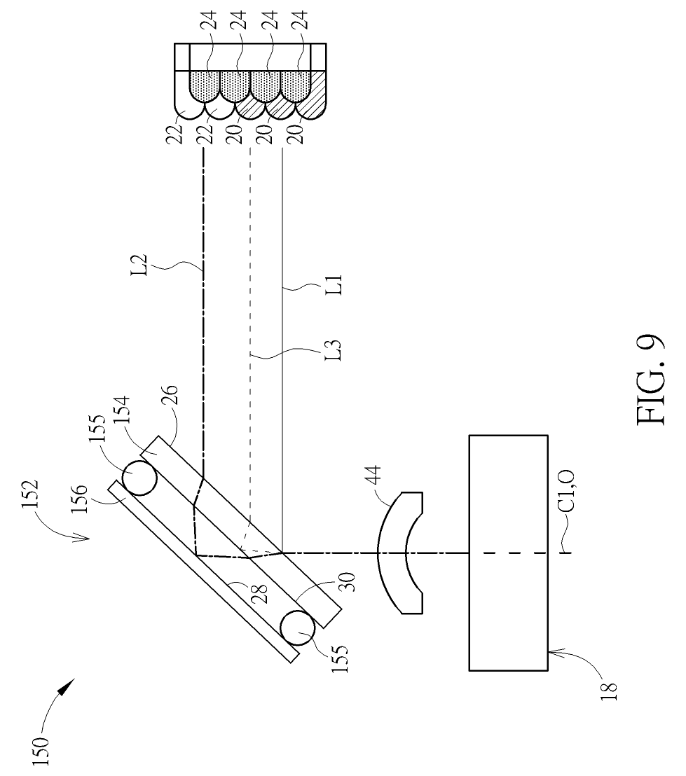

Furthermore, the first light-mixing member of the present invention could adopt a design in which the dichroic mirror and the reflective mirror are spaced apart from each other. For example, please refer to FIGS. 8 and 9. FIG. 8 is a diagram of a multicolor light mixing module 150 according to another embodiment of the present invention. FIG. 9 is a front view of the multicolor light mixing module 150 in FIG. 8. Components both mentioned in this embodiment and the aforesaid embodiments represent components with similar structures or functions, and the related description could be reasoned by analogy according to the aforesaid embodiments and omitted herein. As shown in FIGS. 8 and 9, the multicolor light mixing module 150 includes the first laser set 12, the second laser set 14, a first light-mixing member 152, and the second light-mixing member 18. In this embodiment, the first light-mixing member 152 includes a dichroic mirror 154 and a reflective mirror 156, and has the first refractive surface 26, the reflective surface 28, and the second refractive surface 30. The dichroic mirror 154 and the reflective mirror 156 are oblique to face the first laser set 12 and the second laser set 14 (the inclination angles of the dichroic mirror 154 and the reflective mirror 156 could be preferably equal to 45°, but not limited thereto). The first refractive surface 26 is formed at a light-entrance surface position of the dichroic mirror 154 to reflect the first color light L1 and allow the second color light L2 and the third color light L3 to pass through. The second refractive surface 30 is formed at a back surface position of the dichroic mirror 154 to reflect the third color light L3 and allow the second color light L2 to pass through. The dichroic mirror 154 and the reflective mirror 156 are spaced apart from each other along the normal axis N of the first refractive surface 26 (for example, a spacer 155 in FIG. 9 could be used to separate the dichroic mirror 154 from the reflective mirror 156, but not limited thereto). The reflective surface 28 is formed at a light-entrance surface position of the reflective mirror 156 to reflect the second color light L2 to sequentially pass through the second refractive surface 30 and the first refractive surface 26 and then travel along the first light-mixing axis C1.

In such a manner, via the aforementioned spaced light guiding design and by properly controlling a structural thickness of the dichroic mirror 154 and an air spacing distance between the dichroic mirror 154 and the reflective mirror 156, the first light-mixing member 152 can guide the first color light L1, the second color light L2, and the third color light L3 to travel along the coplanar optical axes (i.e., the first light-mixing axis C1 and the light-exit axis O shown in FIG. 9), so as to provide the coplanar color lights required for the second light-mixing member 18 to perform light mixing on the second light-mixing axis C2. To be noted, in addition to utilizing the second light-mixing member 18 (with the prism column design) as shown in FIG. 8 for subsequent single-axis light mixing, other derivative embodiments for the second light-mixing member (e.g., the reverse light mixing configuration, the single-piece dichroic reflective mirror design, and the two-piece dichroic reflective mirror design) can all be selectively applied to the multicolor light mixing module 150, and the related descriptions could be reasoned by analogy according to the aforesaid embodiments and omitted herein.

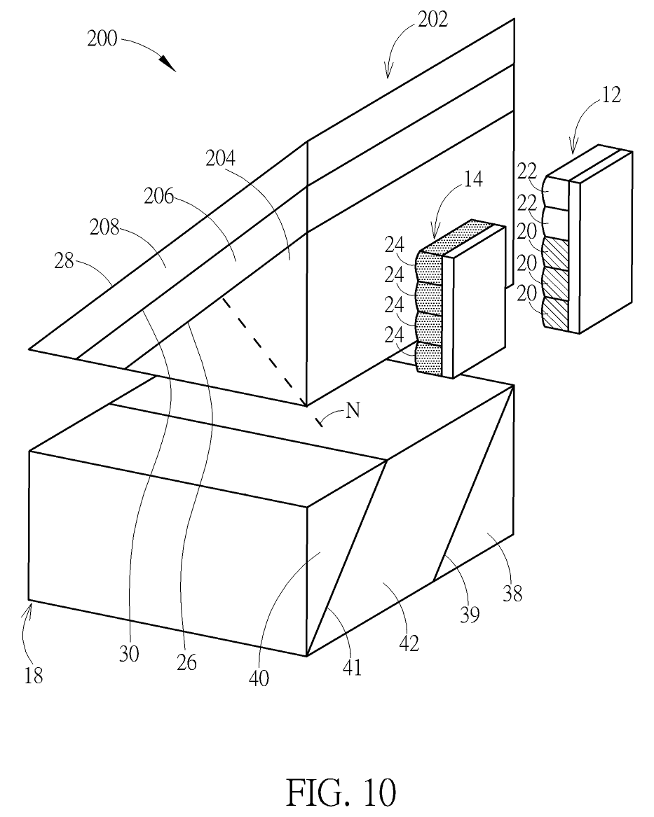

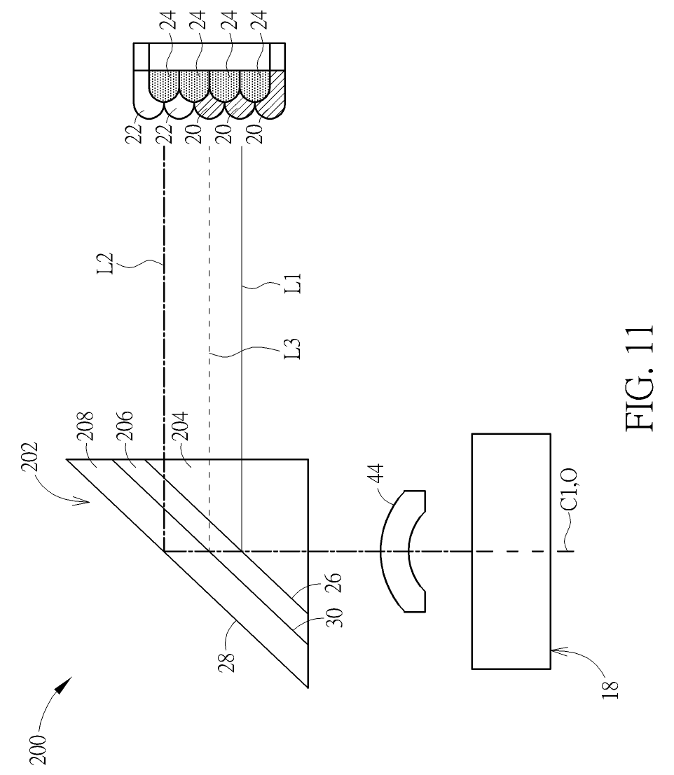

Moreover, the first light-mixing member of the present invention could adopt a triangular prism column design. For example, please refer to FIGS. 10 and 11. FIG. 10 is a diagram of a multicolor light mixing module 200 according to another embodiment of the present invention. FIG. 11 is a front view of the multicolor light mixing module 200 in FIG. 10. Components both mentioned in this embodiment and the aforesaid embodiments represent components with similar structures or functions, and the related description could be reasoned by analogy according to the aforesaid embodiments and omitted herein. As shown in FIGS. 10 and 11, the multicolor light mixing module 200 includes the first laser set 12, the second laser set 14, a first light-mixing member 202, and the second light-mixing member 18. In this embodiment, the first light-mixing member 202 includes a bottom corner prism 204, a middle prism 206, and a top edge prism 208, and has the first refractive surface 26, the reflective surface 28, and the second refractive surface 30. The bottom corner prism 204 has the first refractive surface 26 to allow the second color light L2 and the third color light L3 to pass through and reflect the first color light L1 to travel along the first light-mixing axis C1. The bottom corner prism 204, the middle prism 206, and the top edge prism 208 are sequentially stacked and spliced along the normal axis N of the first refractive surface 26 to cooperatively form a triangular prism column facing the first laser set 12 and the second laser set 14. The middle prism 206 has the second refractive surface 30 to allow the second color light L2 to pass through and reflect the third color light L3 to pass through the first refractive surface 26 and then travel along the light-exit axis O. The top edge prism 208 has the reflective surface 28 to reflect the second color light L2 to sequentially pass through the second refractive surface 30 and the first refractive surface 26 and then travel along the first light-mixing axis C1.

In such a manner, via the aforementioned triangular prism column design and by properly controlling structural thicknesses of the bottom corner prism 204, the middle prism 206, and the top edge prism 208, the first light-mixing member 202 can guide the first color light L1, the second color light L2, and the third color light L3 to travel along the coplanar optical axes (i.e., the first light-mixing axis C1 and the light-exit axis O as shown in FIG. 11), so as to provide the coplanar color lights required for the second light-mixing member 18 to perform light mixing on the second light-mixing axis C2. To be noted, in addition to utilizing the second light-mixing member 18 (with the prism column design) as shown in FIG. 8 for subsequent single-axis light mixing, other derivative embodiments for the second light-mixing member (e.g., the reverse light mixing configuration, the single-piece dichroic reflective mirror design, and the two-piece dichroic reflective mirror design) can all be selectively applied to the multicolor light mixing module 200, and the related descriptions could be reasoned by analogy according to the aforesaid embodiments and omitted herein.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A multicolor light mixing module suitable for providing a multicolor laser beam to a laser projection apparatus, the multicolor light mixing module comprising:
a first laser set comprising a plurality of first lighting units and a plurality of second lighting units arranged in sequence, the plurality of first lighting units emitting a first color light, and the plurality of second lighting units emitting a second color light;
a second laser set adjacent to the first laser set and comprising a plurality of third lighting units arranged in sequence, the plurality of third lighting units emitting a third color light;
a first light-mixing member disposed at a position opposite to the first laser set and the second laser set and having a first refractive surface, a reflective surface, and a second refractive surface, wherein the first refractive surface is disposed obliquely to reflect the first color light to travel along a first light-mixing axis and allow the second color light to pass through and be incident to the reflective surface, the reflective surface is disposed obliquely to reflect the second color light to pass through the first refractive surface and travel along the first light-mixing axis, the second refractive surface is disposed obliquely to reflect the third color light to travel along a light-exit axis, and the light-exit axis is coplanar with the first light-mixing axis; and
a second light-mixing member disposed on the first light-mixing axis and the light-exit axis, for reflecting the first color light, the second color light, and the third color light to form a multicolor laser beam along a second light-mixing axis.

2. The multicolor light mixing module of claim 1, wherein the first light-mixing member comprises a first dichroic mirror and a second dichroic mirror and further has a third refractive surface, the first dichroic mirror faces the first laser set obliquely, the first refractive surface is formed at a light-entrance surface position of the first dichroic mirror, the reflective surface is formed at a back surface position of the first dichroic mirror, the second refractive surface is formed at a back surface position of the second dichroic mirror, the third refractive surface is formed at a light-entrance surface position of the second dichroic mirror, the second dichroic mirror faces the second laser set obliquely and is connected to one side of the first dichroic mirror such that the first refractive surface is flush with the third refractive surface, and a thickness of the first dichroic mirror is greater than a thickness of the second dichroic mirror so that the reflective surface and the second refractive surface are not coplanar; the third refractive surface allows the third color light to pass through, and the second refractive surface reflects the third color light to pass through the third refractive surface and travel along the light-exit axis.

3. The multicolor light mixing module of claim 1, wherein the first light-mixing member comprises a dichroic mirror and a reflective mirror, the dichroic mirror faces the first laser set and the second laser set obliquely, the first refractive surface is formed at a light-entrance surface position of the dichroic mirror, the dichroic mirror and the reflective mirror are stacked along a normal axis of the first refractive surface, the second refractive surface is formed at a position where the reflective mirror is connected to the dichroic mirror, and the reflective surface is formed at a back surface position of the reflective mirror; the first refractive surface reflects the first color light and allows the second color light and the third color light to pass through, the second refractive surface reflects the third color light and allows the second color light to pass through, and the reflective surface reflects the second color light to sequentially pass through the second refractive surface and the first refractive surface and travel along the first light-mixing axis.

4. The multicolor light mixing module of claim 1, wherein the first light-mixing member comprises a dichroic mirror and a reflective mirror, the dichroic mirror and the reflective mirror face the first laser set and the second laser set obliquely, the first refractive surface is formed at a light-entrance surface position of the dichroic mirror, the second refractive surface is formed at a back surface position of the dichroic mirror, the dichroic mirror and the reflective mirror are spaced apart from each other along a normal axis of the first refractive surface, and the reflective surface is formed at a light-entrance surface position of the reflective mirror; the first refractive surface reflects the first color light and allows the second color light and the third color light to pass through, the second refractive surface reflects the third color light and allows the second color light to pass through, and the reflective surface reflects the second color light to sequentially pass through the second refractive surface and the first refractive surface and travel along the first light-mixing axis.

5. The multicolor light mixing module of claim 1, wherein the first light-mixing member comprises a bottom corner prism, a middle prism, and a top edge prism, the bottom corner prism has the first refractive surface to allow the second color light and the third color light to pass through and reflect the first color light to travel along the first light-mixing axis, the bottom corner prism, the middle prism, and the top edge prism are sequentially stacked along a normal axis of the first refractive surface to cooperatively form a triangular prism column facing the first laser set and the second laser set, the middle prism has the second refractive surface to allow the second color light to pass through and reflect the third color light to pass through the first refractive surface and travel along the light-exit axis, and the top edge prism has the reflective surface to reflect the second color light to sequentially pass through the second refractive surface and the first refractive surface and travel along the first light-mixing axis.

6. The multicolor light mixing module of claim 1, wherein the second light-mixing member comprises a first prism column, a second prism column, and a third prism column, the first prism column and the second prism column are respectively disposed on the first light-mixing axis and the light-exit axis, the third prism column is spliced between the first prism column and the second prism column, a first splicing surface of the third prism column and the first prism column is oblique on the first light-mixing axis to reflect the first color light and the second color light to travel along the second light-mixing axis, and a second splicing surface of the third prism column and the second prism column is oblique on the light-exit axis to reflect the third color light to travel along the second light-mixing axis and allow the first color light and the second color light to pass through, so that the third color light is mixed with the first color light and the second color light on the second light-mixing axis.

7. The multicolor light mixing module of claim 1, wherein the second light-mixing member comprises a first prism column, a second prism column, and a third prism column, the first prism column and the second prism column are respectively disposed on the first light-mixing axis and the light-exit axis, the third prism column is spliced between the first prism column and the second prism column, a first splicing surface of the third prism column and the first prism column is oblique on the first light-mixing axis to reflect the first color light and the second color light to travel along the second light-mixing axis and allow the third color light to pass through, and a second splicing surface of the third prism column and the second prism column is oblique on the light-exit axis to reflect the third color light to pass through the first splicing surface, so that the third color light is mixed with the first color light and the second color light on the second light-mixing axis.

8. The multicolor light mixing module of claim 1, wherein the second light-mixing member is a dichroic reflective mirror, a light-entrance surface of the dichroic reflective mirror allows the first color light and the second color light to pass through and reflects the third color light to travel along the second light-mixing axis, and a back surface of the dichroic reflective mirror reflects the first color light and the second color light to pass through the light-entrance surface, so that the first color light and the second color light are mixed with the third color light on the second light-mixing axis.

9. The multicolor light mixing module of claim 1, wherein the second light-mixing member is a dichroic reflective mirror, a light-entrance surface of the dichroic reflective mirror reflects the first color light and the second color light to travel along the second light-mixing axis and allows the third color light to pass through, and a back surface of the dichroic reflective mirror reflects the third color light to pass through the light-entrance surface, so that the third color light is mixed with the first color light and the second color light on the second light-mixing axis.

10. The multicolor light mixing module of claim 1, wherein the second light-mixing member comprises a dichroic mirror and a reflective mirror, the dichroic mirror is oblique on the light-exit axis to reflect the third color light to travel along the second light-mixing axis and allow the first color light and the second color light to pass through, and the reflective mirror is oblique on the first light-mixing axis to reflect the first color light and the second color light to pass through the dichroic mirror, so that the first color light and the second color light are mixed with the third color light on the second light-mixing axis.

11. The multicolor light mixing module of claim 1, wherein the second light-mixing member comprises a dichroic mirror and a reflective mirror, the dichroic mirror is oblique on the first light-mixing axis to reflect the first color light and the second color light to travel along the second light-mixing axis and allow the third color light to pass through, and the reflective mirror is oblique on the light-exit axis to reflect the third color light to pass through the dichroic mirror, so that the third color light is mixed with the first color light and the second color light on the second light-mixing axis.

12. The multicolor light mixing module of claim 1, wherein the first color light is a green light, the second color light is a blue light, and the third color light is a red light.

13. The multicolor light mixing module of claim 1, wherein the multicolor light mixing module further comprises at least one condensing lens disposed between the first light-mixing member and the second light-mixing member for color light condensing.

14. The multicolor light mixing module of claim 13, wherein the condensing lens is disposed on the light-exit axis for condensing the third color light.
